(19) United States
(12) Patent Application Publication
(10) Pub. No.: US 2016/0259416 A1
(43) Pub. Date: Sep. 8, 2016

(54) WEARABLE DEVICE SURFACE HAPTICS INTERACTION

(71) Applicant: IMMERSION CORPORATION, San Jose, CA (US)

(72) Inventor: David Birnbaum, San Jose, CA (US)

(73) Assignee: IMMERSION CORPORATION, San Jose, CA (US)

(21) Appl. No.: 15/058,765

(22) Filed: Mar. 2, 2016

Related U.S. Application Data
(60) Provisional application No. 62/127,709, filed on Mar. 3, 2015.

(51) Int. Cl. G06F 3/01; G04B 19/28; G04G 21/08; G06F 1/16; G06F 3/041

(52) U.S. Cl. CPC G06F 3/016; G06F 1/163; G06F 3/0416; G04G 21/08; G04B 19/283; G06F 2203/04104

(57) ABSTRACT

A wearable apparatus includes a wearable article that is wearable by a person. The wearable apparatus includes a display, an input portion on a surface of the apparatus, and a haptic actuator. A controller is electrically connected to the input portion and the haptic actuator. The controller is programmed to generate haptic drive signals in response to receiving an input signal from the input portion.

### CROSS REFERENCE TO CO-PENDING APLICATION

This document is a utility patent application claiming the benefit of U.S. Provisional Application Ser. No. 62/127,709, filed on Mar. 3, 2015, entitled MULTI TOUCH SURFACE INTERACTION, the entire disclosure of which is incorporated by reference.

### TECHNICAL FIELD

This patent document relates to haptic effects, and more particularly to wearable articles including haptic feedback in response to user interaction with an input surface.

### BACKGROUND

Wearable technology is becoming more advanced and more popular. Some wearable devices provide functions similar to those provided by hand held devices such as smart phones. For example, a smartwatch is a wearable device that includes functionality that is enhanced beyond timekeeping, including mobile communications, media players, scheduling, etc. Some wearable devices are configured to run mobile applications, or “apps,” using a mobile operating system, and thus provide full or nearly full mobile phone capabilities.

Such wearable devices typically provide a user interface including a display and user input. In the case of a smartwatch, the user interface, including both the display and user input are typically arranged on or near the face of the watch.

### SUMMARY

This patent document relates generally to wearable articles that include a user interface. In one aspect, a wearable apparatus includes a wearable article that is wearable by a person. The wearable apparatus includes a display, an input portion, and a haptic actuator. A controller is electrically connected to the input portion and the haptic actuator. The controller is programmed to generate haptic drive signals in response to receiving an input signal from the input portion.

Another aspect is a method of delivering haptic feedback through a wearable article. The method includes receiving an input signal from an input portion of a wearable article. The input portion surrounds a display of the wearable article. A haptic effect is provided in response to the received input signal, and an output is provided to the display in response to the input signal.

In one specific example, the wearable article is a wrist watch, or smartwatch. The watch includes a watch face display with an input portion surrounding the display, and a haptic actuator. A controller is electrically connected to the display, the input portion, and the haptic actuator. The controller is programmed to provide a display signal to the display and transmit haptic drive signals to the haptic actuator in response to receiving an input signal from the input portion,

### BRIEF DESCRIPTION OF THE DRAWINGS

FIG. 1 is a block diagram illustrating aspects of an embodiment of a wearable article.

FIG. 2 is a top view of an example wrist watch embodying the wearable article illustrated in FIG. 1.

FIG. 3 is a block diagram illustrating further aspects of the wearable article illustrated in FIG. 1.

FIG. 4 illustrates further aspects of the wearable article shown in FIG. 1, including an example user interface display.

FIGS. 5A and 5B illustrates further aspects of the wearable article shown in FIG. 1, including further example user interface displays.

FIG. 6 aspects of the wearable article shown in FIG. 1, including an example input area.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” “including,” “has,” and “having” are interchangeable and not intended to be limiting. The term “such as” also is not intended to be limiting. For example, the term “including” shall mean “including, but not limited to.”

In general terms, this patent document relates to a wearable apparatus that includes a user input. While wearable devices such as smartwatches provide convenient and extremely portable technology, the space available for user interfaces is limited. This can make it awkward or difficult for a user to make selections or provide input.

In accordance with aspects of this disclosure, an apparatus includes a display. The display may or may not include a touch screen. The apparatus can also include an input portion on a surface of the apparatus. The apparatus receives input through the input portion. The input portion may be connected to or positioned adjacent to an outer perimeter of the display, and another embodiment, the input portion is integrally formed with the display and is layered on top of or below the display. In yet another embodiment, the input portion is a separate unit that can be attached to the display. In another embodiment, the input portion can physically move or rotate around the display. In yet another embodiment, the input portion does not move or rotate but receives moving or rotating touch input. In another embodiment, the input portion and the display are the same. In yet another embodiment, the input portion is separate from the display and the display may or may not include a touch screen.

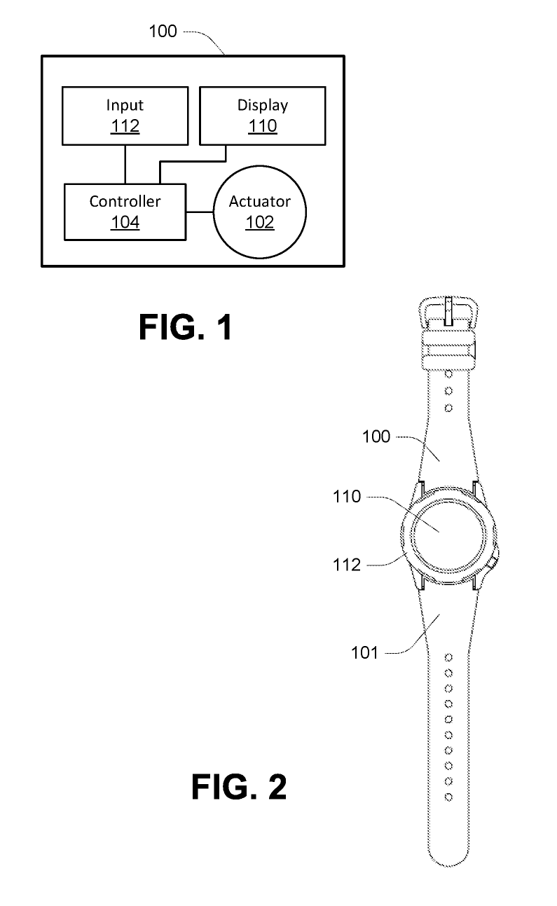

FIG. 1 illustrates aspects an example embodiment in which the article is a wearable apparatus. The wearable apparatus includes a wearable article 100 that is wearable by a person. The wearable article 100 includes a display 110, an input portion 112 on a surface of the article, and a haptic actuator 102. A controller 104 is electrically connected to the input portion 112 and the haptic actuator 102, and is programmed to transmit haptic drive signals to the haptic actuator 102 in response to receiving an input signal from the input portion 112. Further, the controller 104 is coupled to the display 110 to control an output provided to the display 110. For example, the controller 104 may be programmed to output various user interface displays in response to user input received via the input portion 112. The display 110 can be any suitable graphics display device, such as a light-emitting diode (LED) based display. In some embodiments, the display 110 includes a touch screen.

FIG. 2 illustrates an example in which the wearable article 100 is a wrist watch 101 that receives haptic feedback that reacts to the input portion 112, such as a physical wheel or bezel that rotates around the display 110. In the example shown in FIG. 2, the display 110 includes watch face. In other embodiments, the input portion 112 does not move or rotate, and the wearable article 100 receives haptic feedback in response to input to the non-movable or non-rotatable input portion 112.

The controller 104 is any type of circuit that controls operation of the haptic actuator 102 based on receiving a signal or data from the input portion 112. For instance, when a user touches the input portion 112, a signal is input to the controller 104. In response, the controller 104 operates the haptic actuator 102 to provide haptic feedback to the user touching the input portion 112 of the wearable article 100. A haptic effect can be any type tactile sensation delivered to a person. The haptic effect embodies a message such as a cue, notification, or more complex information. The haptic feedback typically embodies a message to the person touching the input portion 112. The message may provide tactile feedback to the user regarding the user's inputs to the wearable article 100 via a surface of the article including the input portion 112.

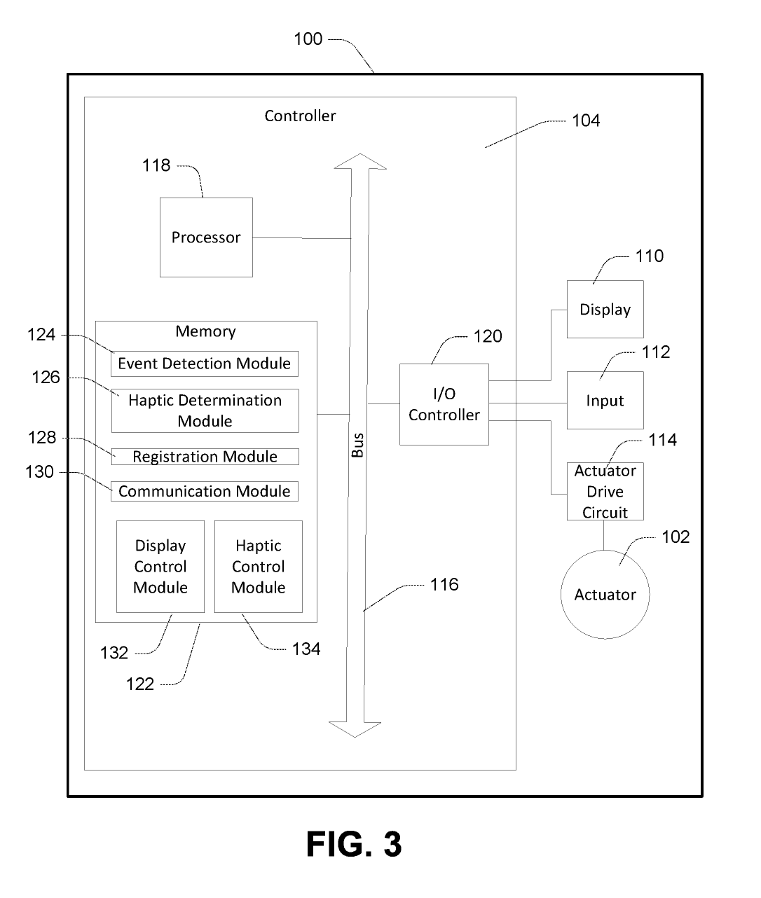

FIG. 3 illustrates a more detailed block diagram of an embodiment of the wearable article 100 illustrated in FIG. 1. In this embodiment, the wearable article 100 includes the haptic actuator 102 and the controller 104. The input portion 112 is in electrical communication with the controller 104 to provide user inputs. An actuator drive circuit 114 is in electrical communication with the controller 104 and the actuator 102.

The actuator 102 can be any device that produces a motion. Examples of actuators include mechanisms such as motors; linear actuators such as solenoids; magnetic or electromagnetic mechanisms; and smart materials such as shape memory alloys, piezoelectric materials, electroactive polymers, and materials containing smart fluids. In some embodiments, the actuator 102 interacts with a surface of the article, such as the portion of the surface having the input portion 112, to provide the haptic feedback to the user touching the input portion 112.

The input portion 112 can be any type of input device that outputs a signal in response to a predetermined action from a user. In some embodiments, the input portion 112 is a touch sensitive device situated on a surface of the article, which could be any type of user input device that outputs a signal in response to being touched. In some embodiments, the input portion 112 includes a touch sensitive device that employs capacitive sensing using human body capacitance as input. The controller 104 receives user input as an input signal generated by the input portion 112. The controller 104 processes the input signal and in response thereto, controls the actuator 102 to deliver a haptic message that may be related to information shown on the display 110.

The actuator drive circuit 114 is a circuit that receives a haptic signal from the controller 104. The haptic signal embodies haptic data, and the haptic data defines parameters the actuator control circuit 114 uses to generate a haptic drive signal. Examples of parameters that can be defined by the haptic data includes frequency, amplitude, phase, inversion, duration, waveform, attack time, rise time, fade time, and lag or lead time relative to an event. The haptic drive signal is applied to the actuator 102.

The example controller 104 comprises a bus 116, processor 118, input/output (I/O) controller 120, and memory 122. The bus 116 includes conductors or transmission lines for providing a path to transfer data between the components in the controller 104 including the processor 118, memory 122, and I/O controller 120. The bus 116 typically comprises a control bus, address bus, and data bus. However, the bus 116 can be any bus or combination of busses, suitable to transfer data between components in the controller 104.

The I/O controller 120 is circuitry that monitors operation of the controller 104 and peripheral or external devices such as the input portion 112, the display 110 and the actuator drive circuit 114. The I/O controller 120 also manages data flow between the controller 104 and the peripheral devices and frees the processor 118 from details associated with monitoring and controlling the peripheral devices. Examples of other peripheral or external devices with which the I/O controller 120 can interface includes external storage devices; monitors; input devices such as keyboards, pointing devices; external computing devices; antennas; and any other remote devices.

The processor 118 can be any circuit configured to process information and can include any suitable analog or digital circuit. The processor 118 also can include a programmable circuit that executes instructions. Examples of programmable circuits include microprocessors, microcontrollers, application specific integrated circuits (ASIC), programmable gate arrays (PLA), field programmable gate arrays (FPGA), or any other processor or hardware suitable for executing instructions. In various embodiments, the processor 118 can be a single unit or a combination of two or more units. If the processor 118 includes two or more units, the units can be physically located in a single controller or in separate devices.

The memory 122 can include volatile memory such as random access memory (RAM), read only memory (ROM), electrically erasable programmable read only memory (EPROM), flash memory, magnetic memory, optical memory, or any other suitable memory technology. The memory 122 also can include a combination of volatile and nonvolatile memory.

The memory 122 can store a number of program modules for execution by the processor 118, including an event detection module 124, a haptic determination module 126, a registration module 128, a communication module 130, a display control module 132, and a haptic control module 134. Each module is a collection of data, routines, objects, calls, and other instructions that perform one or more particular task. Although certain modules are disclosed herein, the various instructions and tasks described herein can be performed by a single module, different combinations of modules, modules other than those disclosed herein, or modules executed by remote devices that are in communication with the controller 104.

The event detection module 124 is programmed to receive data from the input portion 112. Upon receiving the data, the event detection module 124 determines whether there is an event, condition, or operating state associated with a haptic effect. Upon identification of an event associated with a haptic effect, the haptic determination module 126 analyzes the input received from the input portion 112 to determine a haptic effect to deliver through the actuator 102. An example technique the haptic determination module 126 can use to determine a haptic effect includes rules programmed to make decisions to select a haptic effect. Another example includes lookup tables or databases that relate haptic effects to data received from the input portion 112.

The display control module 132 generates an output signal to determine the information provided on the display 110. The display control module vaties the output shown on the display 110 based at least in part on input signals received via the input portion 112. In this manner, a user may determine what content is shown on the display 110.

The haptic control module 134 generates a haptic signal upon the haptic determination module 126 identifying a haptic effect to deliver to the actuator 102. The haptic control module 134 receives haptic data and generates a haptic signal. The haptic control module 134 sends the haptic signal to the actuator drive circuit 114, which then generates the haptic drive signal. The haptic drive signal embodies the message to be conveyed to the person touching the input area 112.

The registration module 128 receives and processes registration data such as device information, context information, or other data used for system functions. The device information may include identifying data such as an address or other data. Examples of addresses include media access control (MAC) addresses, uniform resource locators (URL), or other network addresses.

The communication module 130 facilitates communication between the controller 104 and remote devices. Examples of remote devices include computing devices, sensors, other wearable articles, exercise equipment, etc. Examples of computing devices include servers, desktop computers, laptop computers, tablets, smartphones, home automation computers and controllers, and any other device that is programmable. The communication can take any form suitable for data communication including communication over wireless or wired communication signal or data paths.

Alternative embodiments of the program modules are possible. For example, some alternative embodiments might have more or fewer program modules than the event detection module 124, haptic determination module 126, registration module 128, communication module 130, display control module 132, and haptic control module 134. For example, the controller 104 can be configured to deliver only a single haptic effect. Such embodiments might not have a haptic determination module 126, and the event detection module 124 or some other module would cause the haptic control module 134 to send the haptic data to the haptic control module 134. In other alternative embodiments, there is no event detection module 124 and the haptic control module 134 sends a haptic signal to the actuator control circuit 114 upon the controller 104 receiving an input from the input portion 112.

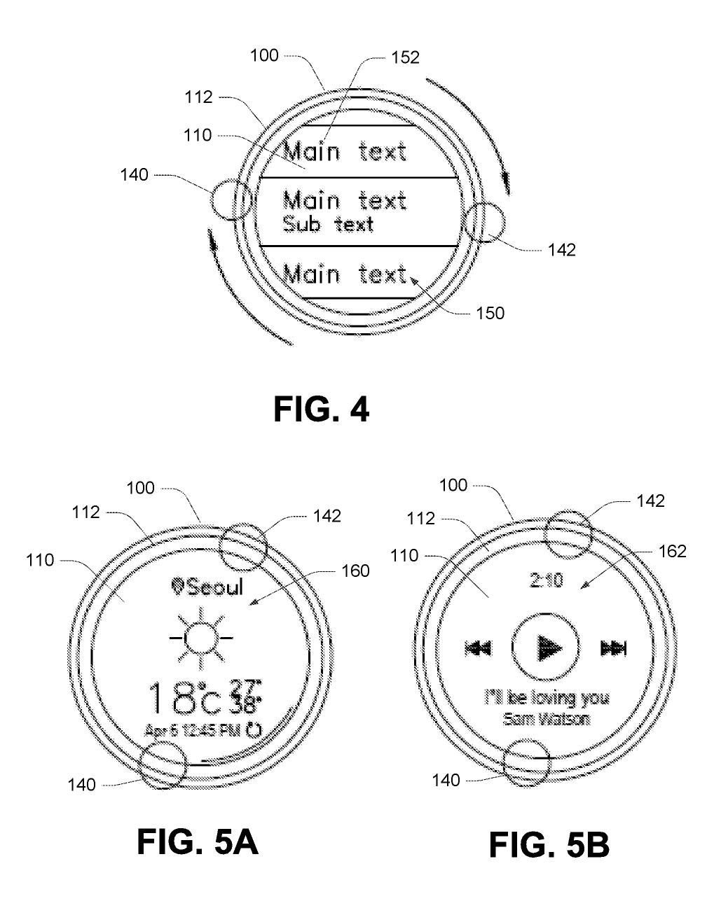

FIG. 4 shows an exemplary embodiment of portions of the wearable device 100, including the display 110 and the input portion 112. In the illustrated embodiment, the user can interact with the input portion 112 of the device 100 to provide input. The device 100 can receive one touch or multiple different touches either in serial or concurrently as the input. While the exemplary embodiment shown in FIG. 4 shows a circular device receiving two simultaneous inputs, one of ordinary skill in the art understands that the device can be any shape: square, rectangular, oval, triangular, sphere, pyramid, etc., and receive anywhere from a single touch input to multiple touch inputs at one time.

FIG. 4 also shows an exemplary application of the device 100. In FIG. 4, a user is scrolling through a list of text 150 by moving one or more input points 140, 142 around the input portion 112 that is surrounding the circular display 110. In other embodiments, a single input point may be used. As the user rotates the input, clockwise or counterclockwise, around the input portion, the list 150 will scroll up or down based on the input. As the user scrolls through the list 150, a haptic effect is applied as the user scrolls the list 150. In one example, the user can receive a haptic effect as each Main text 152 is highlighted on the display 110, providing a “virtual detent” for the user, indicating to the user that the next Main text has been displayed. Such virtual detents also can be used to provide a sense of speed at which the list items are scrolled on the display 110 by increasing the frequency of the haptic effect as the user increases the scroll rate by increasing the rotational or other touch input to the input area 112.

Various types of single or multiple touch inputs are possible. For example, referring the embodiment shown in FIG. 4, a single touch input may scroll the list 150 line-by-line. Further, a haptic effect may be applied as each Main text 152 is highlighted. A double-touch input may switch to a page view, where the list 150 is scrolled a full screen or “page” at a time, with a haptic effect being provided as each page is displayed.

FIGS. 5A and 5B show another exemplary embodiment of an application for the device. In this exemplary embodiment, the user is able to toggle between different applications running on the device 100. As the user moves their input clockwise or counter-clockwise, the device will shift from one application 160 shown in FIG. 5A to another application 162 shown in FIG. 5B. In the illustrated example, the application 160 displays information for a desired city or location, and the application 162 is a music player. In some examples, the display 110 includes a touch screen that allows the user to provide input in addition to the input portion 112 surrounding the display 110. The user may be able to start and stop the selected song in the music player application 162 shown in FIG. 5B, for example, by touching the play or pause symbols shown on the display 110 once the desired application has been selected using the input portion 112 surrounding the display. Moreover, haptic effects may be provided in response to user inputs provided via a touch screen display 100.

In some embodiments, different types of single or multiple touch inputs transmit different user inputs. For example, referring the embodiment shown in FIGS. 5A and 5B, a single rotational touch to the input portion 112 may toggle the display 110 between different applications. Within the selected application, such as the application 160 showing weather conditions for a selected city, a multi touch input may allow the user to select different cities. Still further, single or multi touch inputs may provide different user inputs. For example, referring still to the application 160, a multi touch rotational input in a clockwise direction may allow the user to scroll from city-to-city, and a counterclockwise multi touch rotational input may allow the user to toggle between a Celsius and Fahrenheit temperature display. Similarly, for the music player application 162 shown in FIG. 5B, various combinations of single and multi touch inputs in one or more rotational directions may allow the user to select different songs, adjust volume, reverse or fast forward, etc. Additionally, different haptic effects may be provided based on the user's single or multi touch inputs.

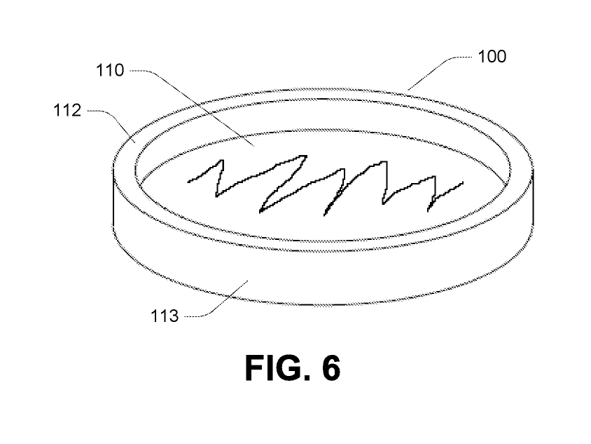

FIG. 6 shows a side view angle of an embodiment of the input portion 112. In one embodiment, the input portion 112 is a surrounding bezel 113 that is raised above the display 110. In yet another embodiment, the input portion 112 may be flush with the display 110. As noted above, the bezel 113 may be physically movable or rotatable around the display 110, and the controller 104 may receive inputs based on the physical movement of the bezel 113 by the user as well as inputs based on the user touching the input portion 112. In other embodiments, the bezel 113 is fixed relative to the display 110 such that the bezel 113 is not movable, wherein rotational movement inputs are received by the controller 104 via the input portion 112.

Several embodiments are specifically illustrated and/or described herein. However, it will be appreciated that modifications and variations of the disclosed embodiments are covered by the above teachings and within the purview of the appended claims without departing from the spirit and intended scope of the invention.

1. A wearable apparatus, comprising:
a wearable article, the wearable article being wearable by a person and comprising a display, an input portion on a surface of the article, and a haptic actuator; and
a controller electrically connected to the input portion and the haptic actuator, the controller programmed to selectively generate haptic drive signals in response to receiving an input signal from the input portion.

2. The wearable apparatus of claim 1, wherein:
the input portion comprises a touch sensitive portion.

3. The wearable apparatus of claim 1, wherein:
the wearable article comprises a wrist watch.

4. The wearable apparatus of claim 1, wherein:
the display comprises a touch screen.

5. The wearable apparatus of claim 1, wherein:
the input portion is positioned adjacent an outer periphery of the display.

6. The wearable apparatus of claim 1, wherein:
the input portion is integrally formed with the display. The wearable apparatus of claim 1, wherein:
the input portion comprises a bezel that surrounds the display.

8. The wearable apparatus of claim 7, wherein:
the input portion is configured to physically move around the display.

9. The wearable apparatus of claim 2, wherein:
the controller is programmed to transmit the haptic drive signals to the haptic actuator in response to a user touching the input portion.

10. The wearable apparatus of claim 9, wherein:
the actuator interacts with the surface of the article having the input portion to provide the haptic feedback to a user touching the input portion.

11. The wearable apparatus of claim 1, wherein:
the controller is programmed to generate a user interface on the display in response to receiving the input signal from the input portion.

12. A method, comprising:
receiving an input signal from an input portion on a surface of a wearable article, the input portion surrounding a display of the wearable article;
providing a haptic effect in response to the received input signal; and
controlling an output provided to the display in response to the input signal.

13. The method of claim 12, wherein:
the wearable article comprises a wrist watch, and wherein the display is a face of the wrist watch.

14. The method of claim 12, wherein:
receiving the input signal comprises receiving a signal from a movable bezel that surrounds the display.

15. The method of claim 12, wherein:
receiving the input signal comprises receiving a signal from a fixed bezel that surrounds the display.

16. The method of claim 12, wherein:
controlling the output provided to the display comprises generating a first display in response to a single touch input and a second display in response to a multi touch input.

17. The method of claim 12, wherein:
controlling the output provided to the display comprises generating a first display in response to a touch input in a first rotational direction and a second display in response to a touch input in a second rotational direction.

18. A wrist watch, comprising:
a watch face display;
an input portion on a surface surrounding the display;
a haptic actuator; and
a controller electrically connected to the display, the input portion, and the haptic actuator, the controller programmed to provide a display signal to the display and transmit haptic drive signals to the haptic actuator in response to receiving an input signal from the input portion.

19. The wrist watch of claim 18, wherein:
the input portion comprises a bezel that surrounds the display, the bezel being configured to physically rotate around the display.

20. The wrist watch of claim 18, wherein:
the controller is programmed to provide a first display in response to a single touch input and a second display in response to a multi touch input.
